(19) United States
(12) Patent Application Publication
(10) Pub. No.: US 2025/0138201 A1
(43) Pub. Date: May 1, 2025

(54) RADIATION IMAGING APPARATUS, RADIATION IMAGING SYSTEM, METHOD OF CONTROLLING RADIATION IMAGING APPARATUS, AND MEDIUM

(71) Applicant: CANON KABUSHIKI KAISHA, Tokyo (JP)

(72) Inventors: TOMOYASU MIZUNO, Tokyo (JP); SHIGEO KOBAYASHI, Kanagawa (JP)

(21) Appl. No.: 18/924,005

(22) Filed: Oct. 23, 2024

(30) Foreign Application Priority Data
Oct. 25, 2023 (JP) 2023-183116
Apr. 24, 2024 (JP) 2024-070255

(51) Int. Cl. G01T 1/17; G01T 7/00

(52) U.S. Cl. CPC G01T 1/17; G01T 7/005

(57) ABSTRACT

To know whether it is required to acquire information on a posture at an appropriate timing in a radiation imaging apparatus, provided is a radiation imaging apparatus for executing radiation imaging based on emitted radiation, the radiation imaging apparatus including: a radiation detection unit which detects radiation; a sensor unit which outputs data serving as a basis of information on a posture of the radiation imaging apparatus; and a determination unit which determines reliability of the information on the posture obtained based on data output from a sensor through use of a threshold value relating to the reliability of the information on the posture and an evaluation value generated based on information on the radiation imaging apparatus including the information on the posture.

### BACKGROUND OF THE INVENTION

### Field of the Invention

The present disclosure relates to a radiation imaging apparatus, a radiation imaging system, a method of controlling a radiation imaging apparatus, and a medium.

### Description of the Related Art

A radiation imaging apparatus including a flat panel detector (FPD) formed of a semiconductor material is currently widely used as a radiation imaging apparatus to be used for medical image diagnosis and nondestructive inspection which uses radiation such as an X-ray. This radiation imaging apparatus is combined with a radiation generation apparatus which generates radiation and the like, and is then used also as a radiation imaging system.

As functions of this radiation imaging system, functions of deriving postures of the radiation generation apparatus and the radiation imaging apparatus and displaying those postures on a display unit or the like have been put into practical use. Those functions are used as a function of supporting positioning between an emission surface of the radiation emitted from the radiation generation apparatus and an incident surface of the radiation imaging apparatus.

For the derivation of the postures of the radiation generation apparatus and the radiation imaging apparatus or information on the postures, for example, an acceleration sensor and a gyroscope are used. Those sensors are provided to each of both of the apparatus, and the posture (position and angle) of each apparatus is derived from accelerations being output values of the acceleration sensor and angular velocities being output values of the gyroscope. However, the posture of the apparatus acquired from those sensors is a sum of change amounts, and hence the current posture of the apparatus cannot correctly be acquired unless a posture before the change serving as a reference (hereinafter referred to as “reference posture”) is known.

In order to avoid this problem, for example, in Japanese Patent Application Laid-Open No. 2021-045647, there is disclosed a radiation image capturing system including an input unit to be used to set a reference posture for a radiation imaging apparatus and a positioning scale which is the structure for positioning. This radiation image capturing system is configured such that a user instructs to set the reference posture via the input unit when the radiation imaging apparatus is brought into abutment against the positioning scale, thereby being capable of setting the reference posture.

However, in the radiation image capturing system as disclosed in Japanese Patent Application Laid-Open No. 2021-045647, it is required to appropriately acquire a posture between a radiation generation apparatus and the radiation imaging apparatus or information on the posture based on the determination of the user. Each of the acceleration sensor and the gyroscope acquires the accumulated amount of the posture, and hence there is a fear that the accumulated amount of the change may vary depending on the timing for the user to acquire the posture between those apparatus.

This variation can cause, depending on the user, a possibility of inducing such an imaging mistake that the imaging is executed while referring to, for example, information on the posture having a large error.

### SUMMARY OF THE INVENTION

The present disclosure has been made in view of the above-mentioned circumstance, and has an object to know whether it is required to acquire information on a posture at an appropriate timing in a radiation imaging system.

In order to solve the above-mentioned problem, according to one aspect of the present disclosure, there is provided a radiation imaging apparatus for executing radiation imaging based on emitted radiation, the radiation imaging apparatus including: a radiation detection unit which detects radiation; a sensor unit which outputs data serving as a basis of information on a posture of the radiation imaging apparatus; and a determination unit which determines reliability of the information on the posture obtained based on data output from a sensor through use of a threshold value relating to the reliability of the information on the posture and an evaluation value generated based on information on the radiation imaging apparatus including the information on the posture.

Further features of the present invention will become apparent from the following description of exemplary embodiments with reference to the attached drawings.

### BRIEF DESCRIPTION OF THE DRAWINGS

FIG. 1 is a diagram for illustrating a configuration example of a radiation imaging system according to a first embodiment.

FIG. 2 is an explanatory diagram for illustrating a coordinate system of posture angles in the first embodiment.

FIG. 3 is a flowchart for illustrating a flow of reliability determination for information on a posture in the first embodiment.

FIG. 4A is a view of an example of GUI display of warning for a reliability decrease in the first embodiment.

FIG. 4B is a view of another example of GUI display of the warning for the reliability decrease in the first embodiment.

FIG. 5 is a flowchart for illustrating a flow of the reliability determination for the information on the posture in a second embodiment.

FIG. 6 is a view of GUI display for prompting resetting of a reference posture in the second embodiment.

FIG. 7 is a flowchart for illustrating a flow of the reliability determination for the information on the posture in a third embodiment.

FIG. 8 is a flowchart for illustrating a flow of a method of correcting the information on the posture in a fourth embodiment.

FIG. 9 is a flowchart for illustrating a flow of another method of correcting the information on the posture in the fourth embodiment.

FIG. 10 is a flowchart for illustrating a flow of the method of correcting the information on the posture in a fifth embodiment.

FIG. 11 is a flowchart for illustrating a flow of the method of correcting the information on the posture in a ready state in the fifth embodiment.

FIG. 12 is a flowchart for illustrating a flow of the method of correcting the information on the posture in a sixth embodiment.

FIG. 13 is a flowchart for illustrating a flow of the reliability determination for the information on the posture in a sleep state in the sixth embodiment.

FIG. 14 is a diagram for illustrating another example of the configuration of the radiation imaging system.

### DESCRIPTION OF THE EMBODIMENTS

Exemplary embodiments of the present disclosure are described below in detail with reference to the accompanying drawings. Positions of components or the like described in the following embodiments are freely set, and can be changed depending on various conditions or configurations of apparatus to which the present disclosure is applied. In the drawings, the same reference symbols are used to denote components that are the same as one another or functionally similar to one another among the drawings.

In the following embodiments, a radiation imaging system using an X-ray as an example of radiation is described. However, the radiation imaging system according to the present disclosure may use other types of radiation. The term “radiation” here may include, for example, electromagnetic radiation such as an X-ray and a γ-ray, as well as particle radiation such as an α-ray, a β-ray, a particle ray, a photon ray, a heavy ion ray, and a meson ray.

### First Embodiment

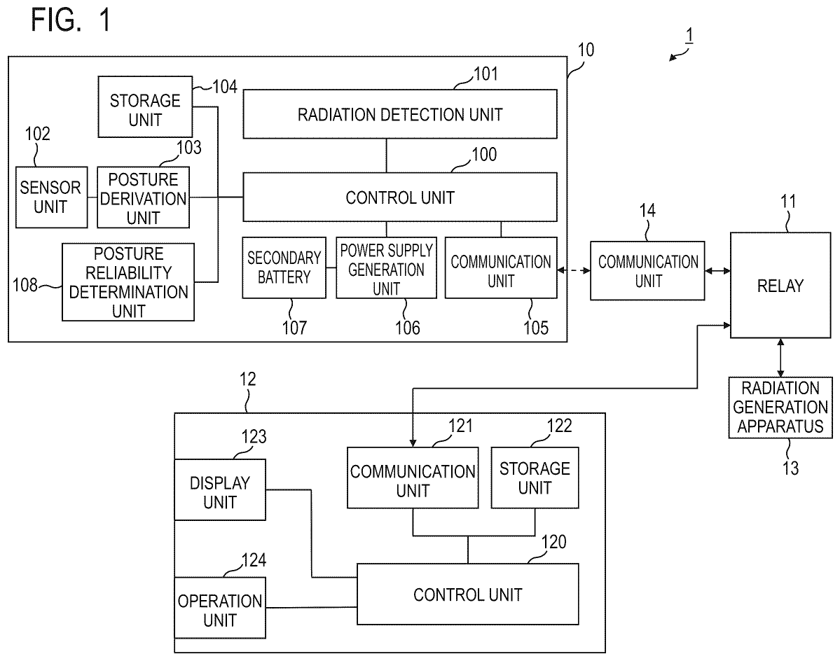

With reference to FIG. 1 to FIG. 4B, a radiation imaging apparatus, a radiation imaging system, an information processing apparatus, a method of controlling a radiation imaging apparatus, and an information processing method according to a first embodiment of the present disclosure are now described. FIG. 1 is a functional block diagram for illustrating a configuration example of a radiation imaging system 1 according to the first embodiment. The radiation imaging system 1 includes a radiation imaging apparatus 10, a relay 11, a radiation generation apparatus 13, and a communication unit 14, which are arranged in an imaging room used to image an object (not shown). Moreover, the radiation imaging system 1 further includes a control apparatus 12 arranged in an operation room used to operate the imaging. A control unit 100 of the radiation imaging apparatus 10 and the control apparatus 12, which are illustrated as independent apparatus, may be integrated with each other.

The radiation imaging apparatus 10 includes the control unit 100, a radiation detection unit 101, a sensor unit 102, a posture derivation unit 103, a storage unit 104, a communication unit 105, a power supply generation unit 106, a secondary battery 107, and a posture reliability determination unit 108. The radiation imaging apparatus 10 communicates to and from the communication unit 14 so that the radiation imaging apparatus 10 can communicate to and from the control apparatus 12 via the relay 11. In FIG. 1, such a configuration that the radiation imaging apparatus 10 executes wireless communication is illustrated, but can also execute wired communication.

In this case, the radiation imaging apparatus 10 is connected to the relay 11 in the wired form without intermediation of the communication unit 14.

The radiation detection unit 101 has a function of detecting radiation emitted from the radiation generation apparatus 13 and having passed through a subject (not shown), to thereby generate digital data on a radiation image of the subject. The radiation detection unit 101 may use a radiation detector of an indirect conversion type which converts the radiation to light through a scintillator and converts the light to electric charges or a radiation detector of a direct conversion type which directly converts the radiation to electric charges.

The sensor unit 102 acquires accelerations and angular velocities as data for deriving posture angles of the radiation imaging apparatus 10. In the first embodiment, the sensor unit 102 is formed of a six-axis inertial measurement unit (IMU) including, for example, an acceleration sensor and a gyroscope. The six-axis IMU is an example, and as long as the IMU includes an acceleration sensor and a gyroscope, such as a nine-axis IMU to which a geomagnetic sensor is added, any IMU can be used as the sensor unit 102. Moreover, when the geomagnetic sensor is also included, output of the geomagnetic sensor can be used to derive the posture angles of the radiation imaging apparatus 10. The radiation imaging apparatus 10 can acquire information for deriving the posture angles and the position of the radiation imaging apparatus 10 from this sensor unit 102 to output the information. For example, the derivation of the posture which uses the gyroscope is executed by accumulating (integrating) the angular velocities in a minute time acquired from the gyroscope. Moreover, the derivation of the posture which uses the acceleration sensor is executed by once accumulating the accelerations acquired from the acceleration sensor to derive speeds at a certain time, and further accumulating the speeds once again to derive displacements (position). In the description given below, the term “information on the posture” generally referring to the information on the posture angle and the position is used for the description.

The posture derivation unit 103 derives the information on the posture of the radiation imaging apparatus 10 through use of the accelerations and the angular velocities acquired from the sensor unit 102. The information on the posture is derived from the posture angles and the position (hereinafter referred to as “reference posture”) of the radiation imaging apparatus 10 at a certain time and data exemplified by the accelerations and the angular velocities acquired from the sensor unit 102.

The control unit 100 executes overall control for an entire system of the radiation imaging apparatus 10, such as drive control for the radiation detection unit 101, conversion and correction processing applied to the image as the digital data acquired by the radiation detection unit 101, and control for the communication unit 105. The control unit 100 is formed of a circuit board including, for example, a CPU, a GPU, and an FPGA. The control unit 100 may execute the function of the posture derivation unit 103, or the functions of the control unit 100 and the posture derivation unit 103 may be implemented in different function regions of the same unit.

The storage unit 104 includes a nonvolatile memory capable of storing a control program, image data, control parameters, and an operation log of the radiation imaging apparatus 10. The nonvolatile memory is given here as an example of the storage unit 104, but the storage unit 104 is not limited to the nonvolatile memory, and may be a volatile memory.

The communication unit 105 has a function of communicating to and from another apparatus arranged independently of the radiation imaging apparatus 10. The communication unit 105 can give and receive various types of information through communication in a wired form or a wireless form to and from the another apparatus. The power supply generation unit 106 generates various power supply voltages and electric currents required for an operation of the radiation imaging apparatus 10 from electric power supplied from the secondary battery 107, and supplies the generated power supply voltages and electric currents to each unit. The secondary battery 107 has a function as a power supply for operating each of the above-mentioned units. The secondary battery 107 may be detachable or may be built into a housing of the radiation imaging apparatus 10. As the secondary battery 107, for example, a lithium-ion battery or an electric double layer capacitor can be used.

The posture reliability determination unit 108 makes determination relating to an accuracy of the information on the posture calculated by the posture derivation unit 103. The information on the posture is derived from the reference posture and the values obtained through the time integration of the accelerations and the angular velocities acquired by the sensor unit 102, and hence errors build up due to various factors and the reliability may decrease. In this case, in order to reset the accuracy, it is required to reset the reference posture. The posture reliability determination unit 108 determines whether or not the reliability of the information on the posture calculated by the posture derivation unit 103 is sufficient in executing the radiation imaging.

The relay 11 has a switching hub function, and connects, for example, the radiation imaging apparatus 10, the control apparatus 12, and the radiation generation apparatus 13 to a network in the first embodiment. Moreover, the relay 11 has a relay function in transmission and reception of signals relating to control for timings of radiation exposure and detection, such as transmitting operation information on the radiation generation apparatus 13 to the radiation imaging apparatus 10.

The control apparatus 12 includes a control unit 120, a communication unit 121, a storage unit 122, a display unit 123, and an operation unit 124. The control unit 120 has a display control function for controlling the display of the display unit 123. Moreover, the control unit 120 has a function of receiving the operation information on the operation unit 124 and displaying the operation information on the display unit 123 and controls the communication unit 121 which transmits and receives the signals so that the radiation imaging apparatus 10 is controlled. The communication unit 121 has a function of executing communication to and from another apparatus such as the radiation imaging apparatus 10. The communication unit 121 gives and receives various types of information such as the operation information and the captured image through communication in a wired form or a wireless form to and from the another apparatus.

The storage unit 122 can store a control program, captured image data, control parameters, an operation log, and the like of the control apparatus 12, and includes a nonvolatile memory. The nonvolatile memory is given here as an example of the storage unit 122, but the storage unit 122 is not limited to the nonvolatile memory, and may be a volatile memory. The display unit 123 includes a graphic user interface (GUI) for operating the radiation imaging apparatus 10, and the user can use the operation unit 124 to operate the GUI. The display unit 123 can execute, for the user, display of information such as an error and a warning, display of the posture information calculated by the posture derivation unit 103, and the like under the control of the control unit 120.

The control apparatus 12 has a function of acquiring information indicating a state of the radiation imaging apparatus 10 at a predetermined timing and displaying this information on the display unit 123 formed of a display and the like, to thereby notify the user of this information.

Moreover, the control apparatus 12 can control the state of the radiation imaging apparatus 10 from the above-mentioned operation room through use of, for example, the GUI of the display unit 123.

The radiation generation apparatus 13 executes control of emitting the radiation from a radiation source (not shown) under a radiation emission condition set in advance. The emission of the radiation from the radiation source can also be executed by the radiation generation apparatus 13 in response to depression of a radiation emission switch or an instruction of the user via the GUI given through use of the display or a touch panel.

As an example of a method of imaging an object, there is an imaging method which, for example, synchronizes the radiation generation apparatus 13 and the radiation imaging apparatus 10 with each other. In this case, information input via a switch or the like is transmitted to the radiation imaging apparatus 10 by the relay 11. After that, the radiation generation apparatus 13 emits the radiation after information on permission of the emission is received from the radiation imaging apparatus 10. Moreover, the radiation generation apparatus 13 can receive, from the control apparatus 12 or the radiation imaging apparatus 10, the information on the posture of the radiation imaging apparatus 10 and relative position/angle information with respect to the radiation source, and can display the received information on a display apparatus such as the display or the touch panel, for example, the display unit 123.

The communication mutually executed between the above-mentioned apparatus may be communication compliant to a communication standard, for example, the RS232C, the USB, or the Ethernet (trademark), or communication which uses a dedicated signal line. Moreover, this communication may be wired communication or wireless communication.

An operation of each unit at the time of the imaging executed through use of the radiation imaging system 1 is described next. The user turns on a power supply of the radiation imaging apparatus 10, to thereby bring about a state in which the imaging is enabled. After that, the user executes position adjustment between the object and an emission region of the radiation emitted from the radiation source. For the position adjustment, the information on the posture angles of the radiation imaging apparatus 10 and the information on the relative position and angle with respect to the radiation source are supplementarily used. Those pieces of information can be displayed on the display unit 123 of the control apparatus 12.

The radiation generation apparatus 13 controls, in response to, for example, the depression of the above-mentioned radiation emission switch, the radiation source such that the radiation is emitted toward the radiation imaging apparatus 10. The radiation emitted from the radiation source enters the radiation imaging apparatus 10 after transmitting through the object. The radiation imaging apparatus 10 generates image data corresponding to the radiation made incident by the control unit 100, and transmits this image data to the control apparatus 12 existing in the operation room by the communication unit 105. The control apparatus 12 displays the received image data on the display unit 123. The user of the radiation imaging system 1 can check the image displayed on the display unit 123 to, for example, determine whether it is required to execute the imaging again. After that, when the user determines that the displayed image is normal, the user executes imaging preparation for another object in a similar procedure.

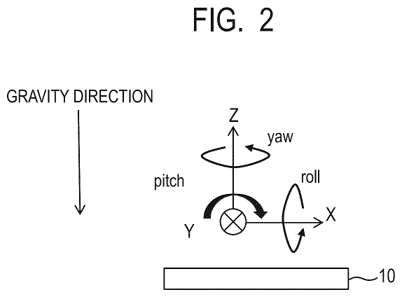

An overview of a method of deriving, by the posture derivation unit 103, information on the posture of the radiation imaging apparatus 10 through use of information acquired from the sensor unit 102 is described next. FIG. 2 shows an example of a method of expressing the posture angles with respect to the gravity direction as a reference. When “x” and “y” axes of the sensor of the sensor unit 102 are set to vertical directions with respect to the gravity, and a “z” axis thereof is set to a parallel direction with respect to the gravity, the posture angles are expressed as roll, pitch, and yaw, respectively, which are rotations about the “x”, “y”, and “z” axes orthogonal to one another.

The posture angles are calculated by applying the Madgwick filter to the accelerations and the angular velocities. The Madgwick filter is a calculation method which can achieve highly-accurate calculation from the information on the accelerations and the angular velocities through use of the quaternion. However, for the yaw angle, information on the rotation direction cannot be acquired from the acceleration information, and hence angle information serving as a reference posture for starting the posture calculation is required. The roll angle and the pitch angle can be calculated from the acceleration information with respect to the gravity direction as a reference, and hence can be calculated even when the reference angle does not exist. In the first embodiment, the example in which the Madgwick filter is used is described, but the filter is not limited to the Madgwick filter, and a complementary filter, a Kalman filter, or the like may be used.

Further, the posture angles may be obtained by executing calculation given by Expression 1 given below which uses only the angular velocity without using a filter. Expression 1 executes calculation of adding, to the reference angle, an amount of movement by an accumulation value of the integration of the angular velocity. The reference angle is represented by θ(0), a measurement time interval for the angular velocity for an angle at a time “t” since the setting of the reference angle is represented by Δt, and the number of times of the measurement is represented by “n” (a relationship of t=n×Δt holds). In this case, each angle of the roll, the pitch, and the yaw at the time “t” is obtained by the calculation as given by Expression 1 for each of the “x”, “y”, and “z” axes.

$$θ = θ ( 0 ) + {\sum }_{k = 1}^{n} ω ( k Δ t ) Δ t \qquad ( Expression 1 )$$

Moreover, the roll angle and the pitch angle can be obtained from only the accelerations, but the yaw angle requires the calculation as given by Expression 1.

The position information on the radiation imaging apparatus 10 can be obtained by obtaining a movement speed through the time integration of the acceleration as given by Expression 2 given below, and further executing time integration of the movement speed as given by Expression 3 for each of the “x”, “y”, and “z” axes.

$$v = v ( 0 ) + {\sum }_{k = 1}^{n} a ( k Δ t ) Δ t \qquad ( Expression 2 )$$

$$d = d ( 0 ) + {\sum }_{k = 1}^{n} v ( k Δ t ) Δ t \qquad ( Expression 3 )$$

The sensor unit 102 rotates, and hence it is required to calculate the “x”, “y”, and “z” directions through correction based on the rotation information at the posture angles obtained as described above. Moreover, v(0) is 0 when the start is made from a stop state, but it is required to set the reference position serving as the start. The reference position is obtained by setting relative coordinates with respect to the radiation generation apparatus 13 so that a distance (SID) between the radiation generation apparatus 13 and the radiation imaging apparatus 10 is known. The reference position may be obtained by directly setting relative coordinates with respect to the radiation generation apparatus 13, but a relative position with respect to any object or a specific position of an examination room may be given as the reference position.

The reference posture can manually be input and set by the user from the operation unit 124. As another example, a location having known position and rotation information may be stored as a home position in the storage unit 104, and the reference position may be set when the radiation imaging apparatus 10 is placed at the home position. As another example, when electric power can be supplied from the outside to the radiation imaging apparatus 10, it may be considered that the radiation imaging apparatus 10 is placed at the home position at the time of detection of the power supply from the outside, and hence the reference posture may be set. Moreover, in a case in which an imaging unit such as a camera can be attached to the radiation generation apparatus 13 and relative posture information between the radiation imaging apparatus 10 and the radiation generation apparatus 13 can be analyzed based on an image of the radiation imaging apparatus 10 captured by this camera, the reference posture may be set based on this relative posture information. The method of setting the reference posture is not limited to one thereof, and any of those methods can be used or any of those methods can be combined.

The posture reliability determination unit 108 is described next. In the first embodiment, the posture reliability determination unit 108 determines whether or not reliability of the information on the posture obtained from the posture derivation unit 103 has fallen below a threshold value (hereinafter referred to as “reliability decrease”). For example, the determination of the reliability decrease can be made based on an elapsed time since the last setting of the reference posture. When the information on the posture is to be calculated, the calculation of the time integration is included in the process of the calculation. Thus, as the time elapses, the calculated amount increases, and an error builds up. Thus, in order to determine a permissible error range in advance, the maximum permissible elapsed time is set as a threshold value in advance, and this threshold value is stored in the storage unit 104. For example, when the maximum permissible elapsed time is set to one hour, and a time longer than one hour has elapsed since the last setting of the reference posture, the posture reliability determination unit 108 determines that the reliability decrease is present. One hour as the maximum permissible elapsed time is an example, and the maximum permissible elapsed time is a value that can be freely set by the user.

Moreover, the determination of the reliability decrease can also be made based on sums of the movement amounts and the rotation amounts of the sensor unit 102 since the last setting of the reference posture. The process of the calculation of the information on the posture is the sum of the time integration with respect to the reference posture. Thus, as the movement amount and the rotation amount increase, the calculated amounts increase and permissible accumulated errors build up. Thus, in order to determine permissible error ranges in advance, calculated permissible movement amount and rotation amount are set as threshold values in advance, and those threshold values are stored in the storage unit 104. After that, when each of the movement amounts and the rotation amounts calculated by the posture derivation unit 103 exceeds the threshold value, the posture reliability determination unit 108 determines that the reliability decrease has occurred. As the values set in the storage unit 104, for example, a movement amount of 1 m and a rotation amount of 360 degrees can be set. The values of the movement amounts and the rotation amounts are an example, and are values that can be freely set by the user. Moreover, the movement amounts and the rotation amounts are exemplified here, but the movement amounts and the rotation amounts may be treated as the change amounts of the posture and the position of the radiation imaging apparatus 10 relating thereto. In this case, the sums of the change amounts of the posture and the position may be set as the threshold values.

Further, the determination of the reliability decrease can also be made based on at least any one of average values of the accelerations and the angular velocities output from the sensor unit 102 since the last setting of the reference posture. When the output values of the accelerations and the angular velocities are small, the output values are likely to be influenced by data noise and the like. Thus, when calculation is continued in this state, errors tend to become large. Thus, in order to determine the permissible error range in advance, the minimum permissible output average value is set as a threshold value in advance, and this threshold value is stored in the storage unit 104. After that, when an output average value of the sensor unit 102 since the last setting of the reference posture has fallen below this value, the posture reliability determination unit 108 determines that the reliability decrease has occurred.

Further, the determination of the reliability decrease can also be made based on presence or absence of impact on the sensor unit 102 since the last setting of the reference posture. The accelerations and the angular velocities output by the sensor possibly greatly displace or greatly vary due to the external impact. Thus, a permissible impact value is set in advance, and, for example, a variation value of at least one of the accelerations and the angular velocities corresponding thereto is stored as a threshold value in the storage unit 104. After that, when at least one of the accelerations or the angular velocities detected since the last setting of the reference posture has exceeded this value, the posture reliability determination unit 108 determines that the reliability decrease has occurred. In this case, the permissible impact value is obtained based on, for example, the square root of a square sum of impact values on the “x”, “y”, and “z” axes, and the presence or absence of the impact can be determined based on whether or not the value of this square root exceeds 10 G. The impact value of 10 G is an example, and is a value that can be freely set by the user. Moreover, the method of calculating the impact value is also an example, and it may be determined that the impact is present when, for example, output of a value of each of the acceleration and the angular velocity on each axis exceeds a predetermined value.

The threshold value to be used for the determination of the reliability decrease which is set in the storage unit 104 can also be changed in accordance with an imaging method. In a case of an imaging method, for example, the skyline photographing which requires an accuracy of angle, a strict value can be set as the threshold value for determining the reliability decrease so that it is possible to early notify the user of the reliability decrease.

The determination method for the reliability decrease is not limited to the above-mentioned methods. For example, a combination of those methods may be used, and more accurate determination of the reliability decrease can be made by selecting one or more of any methods.

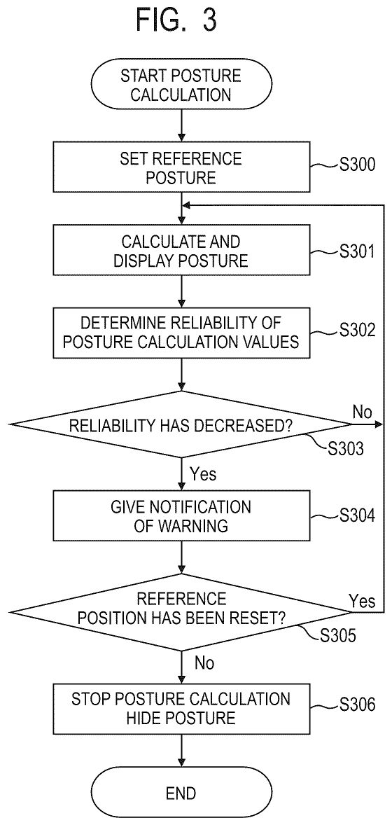

With reference to a flowchart of FIG. 3, an example of a method of carrying out the calculation of the information on the posture and the reliability determination for the calculation values, and a form of use of the determination result is described next. When the calculation of the posture information is started, first, in Step S300, the posture reliability determination unit 108 sets the reference posture for calculating the posture information. As the reference posture, the information on the posture determined in advance at the home position of the radiation imaging apparatus 10 is set. When the reference posture is set, the posture reliability determination unit 108 advances the flow to Step S301.

In Step S301, the posture derivation unit 103 calculates the information on the posture of the radiation imaging apparatus 10. The calculated information on the posture is passed to the control apparatus 12 via the communication unit 105, and the control apparatus 12 serves as a display control unit to control the display unit 123 to display the acquired information on the posture on the display unit 123. After the display of the posture information, the posture reliability determination unit 108 advances the flow to Step S302.

In Step S302, the posture reliability determination unit 108 determines the reliability of the information on the posture calculated by the posture derivation unit 103. The determination of the reliability is made by any one of the above-mentioned methods or a combination of some of those methods. When the determination result is obtained, the posture reliability determination unit 108 advances the flow to Step S303.

In Step S303, a transition destination of the flow is changed in accordance with the determination result of the reliability of the information on the posture. When it is not determined by the posture reliability determination unit 108 that the reliability has decreased, the flow is returned to Step S301, and the calculation and the display of the information on the posture are executed again. An interval of the calculation of the information on the posture in this period can be freely set by the user. When it is determined that the reliability has decreased, the posture reliability determination unit 108 transmits the determination result to the control apparatus 12, and the flow advances to Step S304.

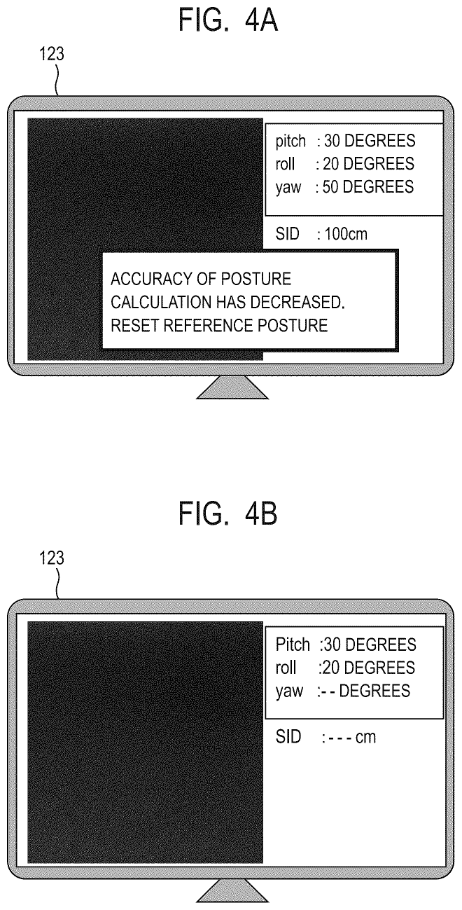

In Step S304, the control apparatus 12 displays, for example, a message of FIG. 4A on the display unit 123 as GUI display in order to notify the user of a warning for the decrease in the accuracy of the posture calculation and the requirement for the resetting. FIG. 4A is a view for exemplifying one form of the message displayed on a display screen of the display unit 123. When the message for the warning is displayed, the posture reliability determination unit 108 advances the flow to Step S305. The form of the notification of the warning to the user is not limited to the display of such a message, and the notification may be given through, for example, a warning sound of a buzzer or the like, or a sound announcement. In the first embodiment, the display unit 123 functions as a notification unit which notifies the user of the warning and the like in the present disclosure.

In Step S305, the posture reliability determination unit 108 checks presence or absence of the resetting of the reference position. When the resetting of the reference position is made, the flow is returned to Step S301. After that, in Step S301, the calculation of the information on the posture and the display of the calculation result are again executed. When the resetting of the reference position is not made, the flow advances to Step S306.

In Step S306, the calculated information on the posture is in the state in which the reliability has decreased, and hence it is considered that appropriate radiation imaging cannot be executed in this state. Thus, in Step S306, subsequent posture calculation is stopped, and the information on the posture is hidden on the display unit 123. FIG. 4B shows an example of GUI display in this case. In this case, as described above, the pitch angle and the roll angle can be calculated from the information on the accelerations and the angular velocities, and hence the reference posture is not necessarily required. Thus, the reliability decrease does not occur. Thus, in the example of FIG. 4B, display of the pitch angle and the roll angle remains, but a display example is not limited to this example. It is only required to allow the user to recognize the decrease in reliability through the display such as hiding of the entire display. When the processing step of Step S306 is finished, a series of processing steps relating to the calculation of the information on the posture and the use of the result thereof described above is finished.

In the first embodiment, for example, the resetting of the reference posture in response to the warning in Step S304 is executed by, for example, placing the radiation imaging apparatus 10 at the home position at which the external power supply is available.

However, the method of resetting the reference posture is not limited to this example, and, for example, the user may use the operation unit 124 to manually input the reference posture. Moreover, when the imaging unit such as a camera is mounted to the radiation generation apparatus 13, an image of the radiation imaging apparatus 10 may automatically be acquired by this camera, and the information on the posture of the radiation imaging apparatus 10 may be calculated from this image by the control apparatus 12.

Through the above-mentioned processing, the reliability of the information on the posture derived by the posture derivation unit 103 can be determined by the posture reliability determination unit 108. Moreover, by displaying the derived information on the posture on the display unit 123 and displaying the decrease in reliability through the determination, it is possible to notify the user of the information on the posture calculated by the posture derivation unit 103 including the appropriateness thereof.

As described above, the radiation imaging apparatus 10 according to the first embodiment executes the radiation imaging of the object based on the emitted radiation. The radiation imaging apparatus 10 includes the radiation detection unit 101, the sensor unit 102, and the determination unit. As described above, the radiation detection unit 101 detects the radiation used for the radiation imaging. The sensor unit 102 outputs the data serving as the basis of the information on the posture such as the accelerations and the angular velocities of the radiation imaging apparatus 10. The posture reliability determination unit 108 in the first embodiment functions as a determination unit in the present disclosure. The determination unit determines the information on the posture output from the sensor unit 102 through use of a threshold value relating to the reliability of the information on the posture and an evaluation value generated based on the information on the posture. In the first embodiment, the posture reliability determination unit 108 can be connected to the notification unit which notifies the user of the decrease in reliability when the evaluation value falls below the threshold value and the posture reliability determination unit 108 determines that the reliability of the information on the posture has decreased. In the first embodiment, the display control unit (control unit 120), which causes the display unit 123 to execute the display for notifying the user of the decrease in reliability, functions as the notification unit in the present disclosure. The notification unit can be arranged in the radiation imaging apparatus 10 itself.

In the first embodiment, the evaluation value can be calculated based on the above-mentioned information on the posture and the reference posture set for the radiation imaging apparatus 10. Moreover, the notification unit described above can also notify the user that the resetting of the reference posture is required when the evaluation value falls below the threshold value and the posture reliability determination unit 108 determines that the reliability of the information on the posture has decreased. This decrease in reliability can be displayed on the display unit 123 to be notified to the user by the control unit 120. Moreover, the notification unit can notify the user of the information on the posture and the position of the radiation imaging apparatus 10 generated as the information which is based on the information (angular velocities and the like) on the posture output from the sensor unit 102. After that, in the first embodiment, when the evaluation value falls below the threshold value and the posture reliability determination unit 108 determines that the reliability of the information on the posture has decreased, the notification unit stops the notification of the generated information on the posture and the position of the radiation imaging apparatus 10 to the user. In the first embodiment, the information on the posture is exemplified as the information on the rotation angle on each of the three axes (“x”, “y”, and “z” axes) orthogonal to one another including the rotation angle about the axis (“z” axis) in the direction parallel with the gravity.

Moreover, in the first embodiment, the evaluation value and the threshold value can include the sums of the change amounts since the reference posture of the posture and the position of the radiation imaging apparatus 10 calculated based on the information on the posture was set and the threshold values for the sums of the change amounts. Further, the evaluation value and the threshold value can include the average values of at least one of the accelerations or the angular velocities of the radiation imaging apparatus 10 calculated based on the information on the posture since the setting of the reference posture and the threshold values for the average values. Further, the evaluation value and the threshold value can include the information on the impact value applied to the radiation imaging apparatus 10 or falling of the radiation imaging apparatus 10 since the setting of the reference posture calculated based on the information on the posture and the threshold value for the information on the impact value or falling. Further, the posture reliability determination unit 108 can determine the reliability of the information on the posture from any one of those evaluation values and threshold values or a combination thereof.

As described above, according to the first embodiment, the control apparatus 12 can control the notification of the information on the posture to the user in accordance with the calculated reliability of the information on the posture. Specifically, by avoiding the notification of the information on the posture having a low accuracy to the user, or notifying the user of the decrease in the accuracy, the control apparatus 12 can prompt the user to reset the reference position. As a result, the user can know whether it is required to acquire information on the posture at an appropriate timing. Further, it is possible to avoid executing the imaging through use of inappropriate information on the posture, and hence it is possible to prevent a mistake in the radiation imaging in advance.

### Second Embodiment

In a second embodiment, the content determined by the posture reliability determination unit 108 is different from that in the first embodiment.

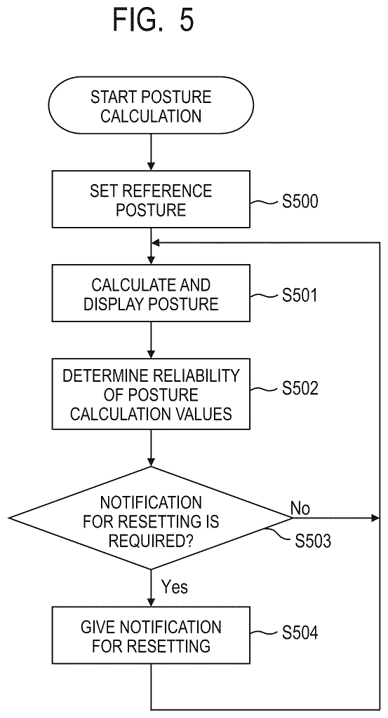

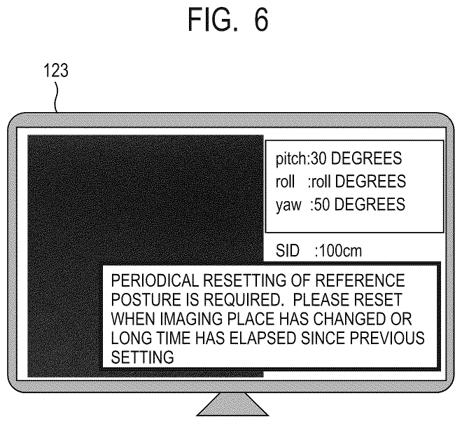

With reference to FIG. 5 and FIG. 6, the second embodiment is now described. The configuration of the radiation imaging system used in the second embodiment is the same as that in the first embodiment and hence description herein is omitted.

The posture reliability determination unit 108 in the second embodiment determines whether or not notification of prompting the resetting of the reference posture is to be given in order to increase the reliability. In the first embodiment, the degree of the reliability decrease is determined through use of the threshold value, and the calculation of the information on the posture and the display thereof are stopped when the reference posture is not reset. In contrast, in the second embodiment, a possibility of the reliability decrease is detected in advance and the user is only prompted to reset the reference posture. The calculation and the display of the information on the posture are not stopped. As a more specific example, in the second embodiment, for example, a case in which the imaging room is changed and the same radiation imaging apparatus 10 is used in a different imaging room is assumed.

In the second embodiment, the determination of the requirement for the notification of the resetting of the reference posture can be made based on presence or absence of a change in patient information. In the X-ray imaging, the information on the patient is input before the imaging, and the X-ray imaging is executed thereafter, to thereby associate the patient information and the captured image with each other. In portable imaging which requires the information on the posture of the radiation imaging apparatus 10, the change in patient is synonymous with a high possibility of great movement of an imaging place, for example, the change in room of the patient. In this case, the error has highly possibly built up in the calculated values of the posture derivation unit 103. Moreover, when the imaging place is changed, it is required to change the reference posture. That is, as a result of the change in imaging place, the reference posture comes to be set to an incorrect posture. Thus, the derived posture information is not correct, and hence it is required to reset the reference posture at a correct posture. Thus, in the second embodiment, when a change in information on the patient has been detected since the last setting of the reference posture, the posture reliability determination unit 108 determines that the notification of the resetting of the reference posture is required.

Moreover, for the determination of the requirement for the notification of the resetting of the reference posture, check-in of the radiation imaging apparatus 10 can also be referred to. In the check-in, it is possible to associate a PC in the imaging place and the radiation imaging apparatus 10 with each other, and to reset, for example, wireless communication information on an access point and the like used at the imaging place. That is, the change in setting of the wireless communication is synonymous with a high possibility of the change in imaging place, and hence it is considered that the resetting of the reference posture is required. Moreover, at the same time, the posture information is highly possibly changed, and hence it is considered that the error has also highly possibly built up in the calculated values of the posture derivation unit 103. Thus, when the posture reliability determination unit 108 has detected the execution of the check-in since the last setting of the reference posture, the posture reliability determination unit 108 determines that the notification of the resetting of the reference posture is required.

For the determination of the requirement for the notification of the resetting of the reference posture, presence or absence of switching between the wireless communication and the wired communication which are the communication methods of the communication unit 105 of the radiation imaging apparatus 10 can also be referred to. The radiation imaging apparatus 10 can be of a portable type. In this case, a case of the wireless communication and a case of the wired communication are possibly switched therebetween in accordance with the imaging environment of the user. That is, when the wired communication and the wireless communication are switched therebetween, the imaging place is highly possibly changed. Thus, it is estimated that the resetting of the reference posture is required, and it is considered that the error has highly possibly built up in the calculated values of the posture derivation unit 103. Thus, when the posture reliability determination unit 108 detects the switching between the wired communication and the wireless communication since the last setting of the reference posture, the posture reliability determination unit 108 determines that the notification of the resetting of the reference posture is required.

Further, for the determination of the requirement for the notification of the resetting of the reference posture, it is also possible to refer to execution of processing for the transition to a ready state at the time of imaging preparation completion of the radiation imaging apparatus 10. The radiation imaging apparatus 10 is brought into a sleep state in order to suppress consumed electric power when the radiation imaging apparatus 10 is not used for the imaging. After that, immediately before the imaging, the radiation imaging apparatus 10 is caused to transition to a ready state, and then the radiation imaging is executed. Moreover, when the patient is to be changed, the radiation imaging apparatus 10 is once returned to the sleep state, and is caused to transition to the ready state after the patient information is changed. That is, it is considered that the transition to the ready state is synonymous with a high possibility of the change in patient and the movement of the imaging place. In this case, it is estimated that the resetting of the reference posture is required, and it is considered that the error has highly possibly built up in the calculated values of the posture derivation unit 103. Thus, when the radiation imaging apparatus has transitioned to the ready state since the last setting of the reference posture, the posture reliability determination unit 108 determines that the notification of the resetting of the reference posture is required.

Further, for the determination of the requirement for the notification of the resetting of the reference posture, for each item of the threshold value used for the determination of the reliability decrease described in the first embodiment, the above-mentioned condition can also be relaxed to be used. For example, when the elapsed time is used as the determination item, one hour is set as the threshold value for the determination of the reliability decrease in the first embodiment, but it is possible to determine that the resetting notification is required when 30 minutes have elapsed in the second embodiment. As described above, in the second embodiment, the posture reliability determination unit 108 makes such a setting that the requirement for the resetting notification is determined before the determination result indicating the reliability decrease is output.

The posture reliability determination unit 108 in the second embodiment determines the reliability of the information on the posture through use of the threshold value relating to the reliability of the information on the posture and the evaluation value generated based on the information on the radiation imaging apparatus 10 including the information on the posture. As the information on the radiation imaging apparatus 10, the presence or absence of the change in patient information, the presence or absence of the change in communication form, the presence or absence of the change in setting of the wireless communication, the presence or absence of the change from the sleep state to the ready state, and the like can be exemplified. In this case, the communication form is the form of the communication units (communication units 14 and 105) which connect the external apparatus (11 and 12) arranged independently of the radiation imaging apparatus 10 and the radiation imaging apparatus 10 to each other, and includes at least any one of the wired form or the wireless form. The setting of the wireless communication includes the setting of the wireless communication executed between the communication unit 105 and the communication unit 14 which function as the wireless communication units for wireless communication to and from the external apparatus (11 and 12) arranged independently of the radiation imaging apparatus 10. Moreover, the change from the sleep state to the ready state includes the change in state of the radiation imaging apparatus 10 from the sleep state to the ready state. The posture reliability determination unit 108 can determine that the reliability has fallen below the threshold value when, as the evaluation value, at least one of the change in patient information, the change in communication form, the change in setting, or the change in state has occurred. Moreover, in the second embodiment, the posture reliability determination unit 108 can be connected to the notification unit (123) which notifies the user that the resetting of the reference posture of the radiation imaging apparatus 10 is required when the reliability is determined to have decreased.

For the determination of the requirement for the notification of the resetting by the posture reliability determination unit 108 in the second embodiment described above, the above-mentioned determinations can be combined to be used. It is possible to determine whether the notification of the resetting of the reference posture is required by selecting one or more of the above-mentioned conditions, and setting the selected one or more conditions as the determination criteria in the second embodiment.

With reference to FIG. 5, each processing step executed for the calculation of the information on the posture and the reliability determination based on the obtained calculation values in the second embodiment is described next. In the second embodiment, in Step S500, Step S501, and Step S502, processing steps similar to those in Step S300, Step S301, and Step S302, respectively, in the first embodiment is executed. Specifically, the setting of the reference posture, the calculation of the information on the posture, the display of the calculated information, and the reliability determination for the obtained information on the posture are sequentially executed. After the end of the reliability determination, the posture reliability determination unit 108 advances the flow to Step S503.

In Step S503, the posture reliability determination unit 108 checks whether or not the result of the determination made in Step S502 indicates that the resetting of the reference posture is required. When the resetting is determined not to be required, the flow is returned to Step S501. After that, in Step S501, the calculation of the information on the posture and the display of the calculation result are executed again. When the resetting is determined to be required, the posture reliability determination unit 108 advances the flow to Step S504.

In Step S503, in order to avoid an actual decrease in the reliability of the calculated information on the posture, it is determined that the resetting of the reference posture is currently required. Thus, in Step S504, the control apparatus 12 displays a message as illustrated in FIG. 6 which prompts the resetting of the reference posture on the display unit 123. FIG. 6 is a view for exemplifying one form of the message displayed on the display screen of the display unit 123. After the requirement for the resetting is notified to the user through the display unit 123, the flow is returned to Step S501 regardless of whether the resetting is executed. After that, the calculation of the information on the posture and the display of the calculation result are continued.

Through the execution of the above-mentioned processing, the requirement for the resetting of the reference posture can be notified to the user based on the determination result for the information on the posture obtained by the posture reliability determination unit 108.

As described above, according to the second embodiment, in accordance with the reliability of the calculated information on the posture, the control apparatus 12 can control the notification of whether it is required to reset the reference posture to the user. That is, the user can know whether it is required to acquire the information on the posture at an appropriate timing. It is possible to maintain a highly accurate calculation state of the posture information by notifying the user that the resetting is required at the stage before the decrease in reliability is determined as described above, and hence it is possible to prevent redoing of the posture control immediately before the radiation imaging and the like. Moreover, it is possible to avoid the imaging by the user through use of inappropriate information on the posture, and hence the mistake in the radiation imaging can be prevented in advance.

### Third Embodiment

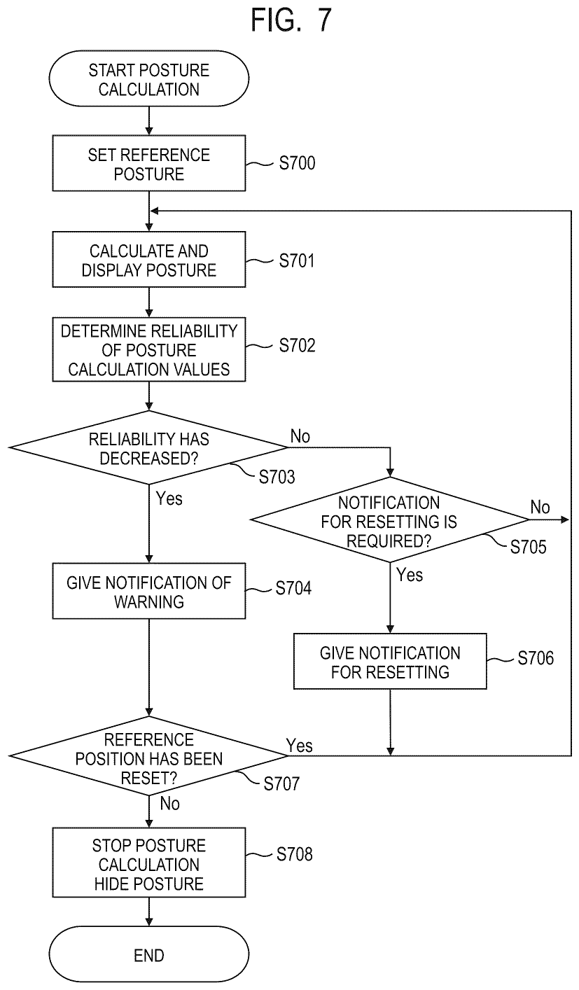

In a third embodiment, in the reliability determination for the information on the posture, the determination described in the first embodiment and the determination described in the second embodiment are combined. With reference to a flowchart of FIG. 7, the determination of the reliability of the information on the posture and the information notified to the user in relation to this reliability executed in the third embodiment are now described. A configuration of the radiation imaging system according to the third embodiment is the same as that in the first embodiment, and hence description herein is omitted.

As the reliability determination for the information on the posture in the third embodiment, both of the determination relating to the requirement for the resetting of the reference posture and the determination for the reliability decrease in information on the posture are executed. For the determination criteria, it is assumed that the determination criteria described in the first embodiment and the second embodiment are directly applied.

With reference to FIG. 7, each processing step executed for the calculation of the information on the posture and the reliability determination based on the obtained calculation values in the third embodiment is now described. In the third embodiment, in Step S700, Step S701, and Step S702, processing steps similar to those in Step S300, Step S301, and Step S302, respectively, in the first embodiment are executed. Specifically, the setting of the reference posture, the calculation of the information on the posture, the display of the calculated information, and the reliability determination for the obtained information on the posture are sequentially executed. After the end of the reliability determination, the posture reliability determination unit 108 advances the flow to Step S703.

In Step S703, the posture reliability determination unit 108 checks whether or not the result of the determination made in Step S702 indicates the decrease in reliability. When the posture reliability determination unit 108 determines that the reliability has not decreased, the flow advances to Step S705. In Step S705, as in Step S503 in the second embodiment, it is determined whether or not the determination result indicates the resetting of the reference posture is required. When the posture reliability determination unit 108 determines that the resetting is not required, the flow is returned to Step S701. After that, in Step S701, the calculation of the information on the posture and the display of the calculation result are executed again. When the posture reliability determination unit 108 determines that the resetting is required, the posture reliability determination unit 108 advances the flow to Step S706.

In Step S705, in order to avoid an actual decrease in the reliability of the calculated information on the posture, it is determined that the resetting of the reference posture is currently required. Thus, in Step S706, the control apparatus 12 displays the message as illustrated in FIG. 6, which prompts the resetting of the reference posture, on the display unit 123. After the requirement for the resetting is notified to the user through the display unit 123, the flow is returned to Step S701 regardless of whether the resetting is executed. After that, the calculation of the information on the posture and the display of the calculation result are continued.

When the posture reliability determination unit 108 determines that the reliability has decreased in Step S703, the flow advances to Step S704. In Step S704, the control apparatus 12 displays, for example, the message of FIG. 4A on the display unit 123 as GUI display in order to notify the user of the warning for the decrease in the accuracy of the posture calculation and the requirement for the resetting. When the message for the warning is displayed, the posture reliability determination unit 108 advances the flow to Step S707. The form of the notification of the warning to the user is not limited to the display of such a message, and the notification may be given through, for example, a warning sound of a buzzer or the like, or a sound announcement.

In Step S707, the posture reliability determination unit 108 checks whether the resetting of the reference position has been executed. When the resetting of the reference position has been executed, the flow is returned to Step S701. After that, in Step S701, the calculation of the information on the posture and the display of the calculation result are executed again. When the resetting of the reference position has not been executed, the flow advances to Step S708.

In Step S707, the calculated information on the posture is in the state in which the reliability has decreased, and it is determined that appropriate radiation imaging cannot be executed in this state. Thus, in Step S708, subsequent posture calculation is stopped and the information on the posture is hidden on the display unit 123.

Through the execution of the above-mentioned processing, the requirement for the resetting of the reference posture can be notified to the user based on the determination result for the information on the posture obtained by the posture reliability determination unit 108. Moreover, the reliability of the information on the posture derived by the posture derivation unit 103 can simultaneously be determined. After that, it is possible to notify the user of the information on the posture calculated by the posture derivation unit 103 including the appropriateness thereof by executing the display of the derived information on the posture on the display unit 123 and the display of the determined decrease in reliability.

As described above, according to the third embodiment, in accordance with the reliability of the calculated information on the posture, the control apparatus 12 can control the request for the resetting of the reference posture to the user. The state in which highly accurate posture information is calculated can be maintained by notifying the user of the state before the reliability decrease is determined or a possible change in imaging place as described above. Moreover, it is possible to prompt the user to reset the reference position by avoiding the notification of the information on the posture having a low accuracy to the user, or notifying the user of the decrease in accuracy. As a result, the user can know whether it is required to acquire the information on the posture at an appropriate timing. Further, it is possible to avoid executing the imaging through use of erroneous information on the posture, and hence it is possible to prevent the mistake in the radiation imaging in advance.

### Fourth Embodiment

It can be assumed that a sensor output value temporarily increases due to a contact of the radiation imaging apparatus with an imaging support or an object at the time of the preparation of the imaging after the setting of the reference posture in the radiation imaging. There is a fear that such a great change in sensor output may cause the posture of the apparatus derived from the sensor output to deviate from the actual posture. A fourth embodiment aims to assume this case to take measures. Specifically, in the fourth embodiment, a method of determining the presence or absence of the impact in the reliability determination for the information on the posture and correcting the accelerations and the angular velocities output by the sensor unit 102 or the information on the posture calculated by the posture derivation unit 103 is described. A configuration of the radiation imaging system according to the fourth embodiment is the same as that in the first embodiment, and hence description herein is omitted.

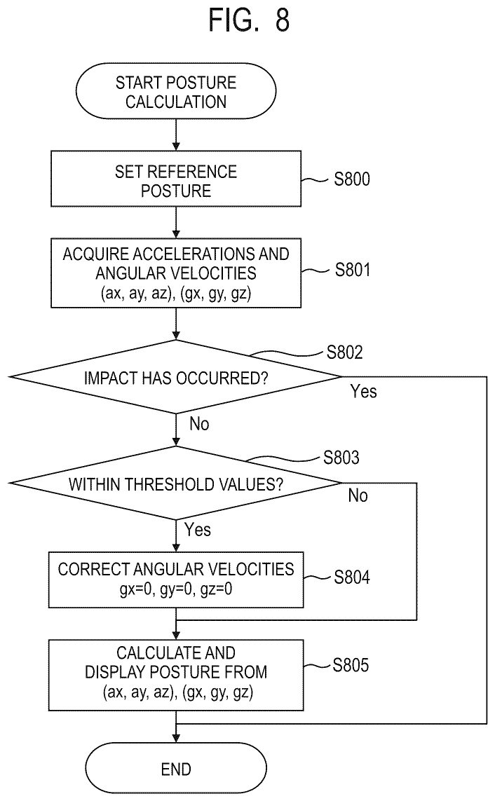

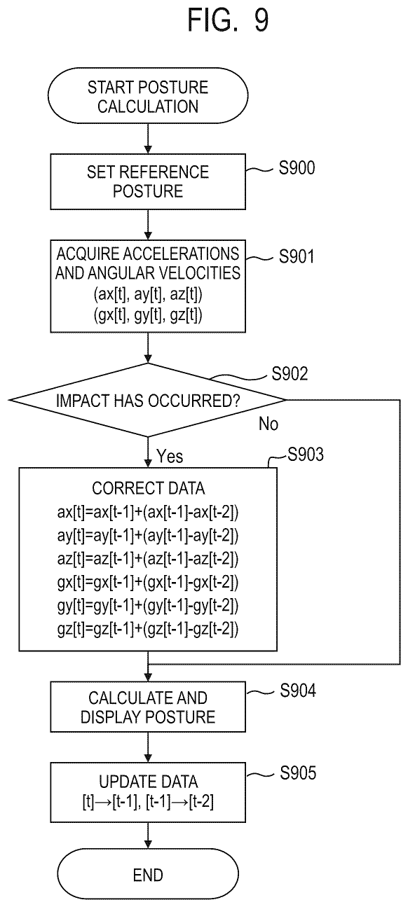

With reference to flowcharts of FIG. 8 and FIG. 9, the method of determining the presence or absence of the impact and correcting the information on the posture is now described.

With reference to FIG. 8, an example of an embodiment for determining the presence or absence of the impact and correcting the information on the posture is first described. When the correction processing for the information on the posture is started, first, in Step S800, the posture reliability determination unit 108 sets the reference posture for calculating the posture information. As the reference posture, the information on the posture determined in advance at the home position of the radiation imaging apparatus 10 is set. When the reference posture is set, the posture reliability determination unit 108 advances the flow to Step S801.

In Step S801, the posture reliability determination unit 108 acquires the accelerations (ax, ay, az) and the angular velocities (gx, gy, gz) on the “x”, “y”, and “z” axes from the sensor unit 102. When the accelerations and the angular velocities are acquired, the posture reliability determination unit 108 advances the flow to Step S802.

In Step S802, the posture reliability determination unit 108 determines the presence or absence of the impact on the radiation imaging apparatus 10 from the acquired accelerations (ax, ay, az) and angular velocities (gx, gy, gz). The determination of the presence or absence of the impact can be made through, for example, comparison between the output of the value of each of the acceleration and the angular velocity on each axis and a predetermined value for determining the presence or absence of the impact that can be freely set by the user. For example, when the output value exceeds the predetermined value, it is possible to determine the presence of the impact. When the absence of the impact is determined, the posture reliability determination unit 108 advances the flow to Step S804. When the presence of the impact is determined, the series of processing steps relating to the determination of the posture and the correction is finished.

In Step S803, the posture reliability determination unit 108 determines whether or not each of the acquired angular velocities (gx, gy, gz) is within a predetermined threshold value. For the predetermined threshold value, for example, each threshold value for each of the angular velocity on each axis can freely be set in order to remove influence of vibration and noise and the like. When the acquired angular velocities are determined to be within the predetermined threshold values, the posture reliability determination unit 108 advances the flow to Step S804. When the acquired angular velocities are determined not to be within the predetermined threshold values, the posture reliability determination unit 108 advances the flow to Step S805.

In Step S804, the posture derivation unit 103 sets the values of the angular velocities (gx, gy, gz) to (0, 0, 0). When the setting of the angular velocities is finished, the posture reliability determination unit 108 advances the flow to Step S805. In the fourth embodiment, the posture derivation unit 103 functions as a correction unit which corrects the information on the posture in Step S804 and Step S805 described later. However, a function region which executes this correction processing may be provided to a part of the posture derivation unit 103 or independently of the posture derivation unit 103.

In Step S805, the posture derivation unit 103 calculates the information on the posture from the new accelerations (ax, ay, az) and angular velocities (gx, gy, gz) acquired based on the set angular velocities. The calculated information on the posture is transmitted to the control apparatus 12, and this information on the posture is displayed on the display unit 123 by the control unit 120. When the display of the information on the posture is finished, the series of processing steps relating to the determination and the correction of the posture is finished.

With reference to FIG. 9, another example of the method of determining the presence or absence of the impact on the radiation imaging apparatus 10 and correcting the information on the posture by a method different from that of FIG. 8 is described next.

In the method exemplified in FIG. 9, acceleration data and angular velocity data are set as follows. Accelerations acquired at a time [t] are represented by (ax[t], ay[t], az[t]), and angular velocities acquired at the time [t] are represented by (gx[t], gy[t], gz[t]). Accelerations acquired at a time [t−1] one time before the time [t] are represented by (ax[t−1], ay[t−1], az[t−1]), and angular velocities acquired at the time [t−1] one time before the time [t] are represented by (gx[t−1], gy[t−1], gz[t−1]). Moreover, accelerations acquired at a time [t−2] two times before the time [t] are represented by (ax[t−2], ay[t−2], az[t−2]), and angular velocities acquired at the time [t−2] two times before the time [t] are represented by (gx[t−2], gy[t−2], gz[t−2]). In an initial state, pieces of data on all of the accelerations and angular velocities are set to 0.

When the correction processing for the information on the posture is started, first, in Step S900, the posture reliability determination unit 108 sets the reference posture for calculating the posture information. As the reference posture, the information on the posture determined in advance at the home position of the radiation imaging apparatus 10 is set. When the reference posture is set, the posture reliability determination unit 108 advances the flow to Step S901.

In Step S901, the posture reliability determination unit 108 acquires the accelerations (ax[t], ay[t], az[t]) and the angular velocities (gx[t], gy[t], gz[t]) on the “x”, “y”, and “z” axes from the sensor unit 102. When the accelerations and the angular velocities are acquired, the posture reliability determination unit 108 advances the flow to Step S902.

In Step S902, the posture reliability determination unit 108 determines the presence or absence of the impact from the accelerations and the angular velocities at the time [t]. The determination of the presence or absence of the impact can be made through, for example, comparison between the output of the value of each of the acceleration and the angular velocity on each axis and a predetermined value for determining the presence or absence of the impact that can be freely set by the user. For example, when the output value exceeds the predetermined value, it is possible to determine the presence of the impact. When the presence of the impact is determined, the posture reliability determination unit 108 advances the flow to Step S903. When the absence of the impact is determined, the posture reliability determination unit 108 advances the flow to Step S904.

In Step S903, the posture derivation unit 103 calculates the accelerations and the angular velocities at the time [t] by estimating the accelerations and the angular velocities from gradients of the accelerations and the angular velocities between the time [t−1] and the time [t−2]. For example, the “x” component ax[t] of the acceleration is calculated by adding, to the acceleration ax[t−1], a difference between the acceleration ax[t−1] and the acceleration ax[t−2]. The accelerations and the angular velocities of other components can similarly be calculated from the accelerations and the angular velocities at the time [t−1] and the time [t−2]. When the calculation of the accelerations and the angular velocities at the time [t] is finished, the posture reliability determination unit 108 advances the flow to Step S904.

In Step S904, the posture derivation unit 103 calculates the information on the posture from the estimated accelerations (ax[t], ay[t], az[t]) and angular velocities (gx[t], gy[t], gz[t]). The calculated information on the posture is transmitted to the control apparatus 12, and this information on the posture is displayed on the display unit 123 by the control unit 120. When the display of the information on the posture is finished, the posture reliability determination unit 108 advances the flow to Step S905.

In Step S905, the posture reliability determination unit 108 sets data on the accelerations and the angular velocities at the time [t−1] to data on the accelerations and the angular velocities at the time [t−2], and sets data on the accelerations and the angular velocities at the time [t] to data on the accelerations and the angular velocities at the time [t−1]. When the setting of the data is finished, the series of processing steps relating to the determination and the correction of the posture is finished.

In the fourth embodiment, the presence or absence of the impact is estimated from the data on the accelerations and the angular velocities, and the output of the sensor unit 102 is corrected. However, the method of estimating the presence or absence of the impact and the like are not limited to the example described herein, and it is also possible to estimate the presence or absence of the impact from a result of the posture information roll, pitch, and yaw calculated from the accelerations and the angular velocities in place of the accelerations and the angular velocities. Moreover, in such a case, the posture information roll, pitch and yaw at the time of the calculation of the information on the posture may be used for the correction of the output of the sensor unit 102.

As described above, according to the fourth embodiment, in accordance with the presence or absence of the impact, the control apparatus 12 can correct the accelerations and the angular velocities output from the sensor unit 102 or the information on the posture obtained based on this output. That is, after the reference posture is set, it is possible to acquire accurate information on the posture which is not influenced by the impact caused by the contact of the radiation imaging apparatus with the imaging support or the object at the time of the execution of the imaging preparation.

### Fifth Embodiment

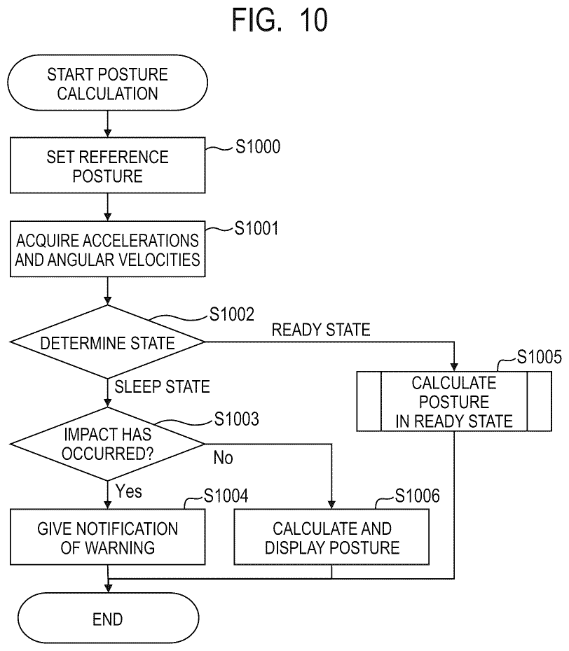

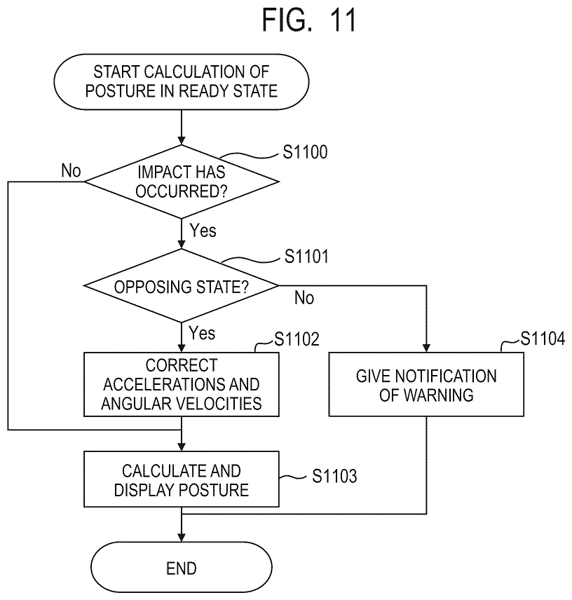

In a fifth embodiment, the reliability of the information on the posture is determined in accordance with the state of the radiation imaging apparatus, and the information on the posture output by the sensor unit 102 is corrected. With reference to flowcharts of FIG. 10 and FIG. 11, a method of determining the presence or absence of the impact and correcting the information on the posture output by the sensor unit 102 is now described. A configuration of the radiation imaging system according to the fifth embodiment is the same as that in the first embodiment, and hence description herein is omitted.

The radiation imaging apparatus 10 is brought into the sleep state in order to suppress the consumed electric power when the radiation imaging apparatus 10 is not used for the imaging. After that, immediately before the imaging, the radiation imaging apparatus 10 is caused to transition to the ready state, and then the radiation imaging is executed. When, for example, the radiation imaging apparatus 10 comes in contact with the imaging support or the object at the time of the transition to the ready state to prepare for the imaging, a case in which the output values of the sensor unit 102 are not stable due to the impact caused by this contact may be assumed. Thus, the notification of prompting the resetting of the reference posture is given through the reliability determination processing described in the first embodiment in the sleep state, and the correction processing for the information on the posture is executed in the ready state. The determination processing is switched in accordance with the apparatus state.

With reference to FIG. 10, a method of determining the presence or absence of the impact and correcting the information on the posture is described next. When the correction processing for the information on the posture is started, first, in Step S1000, the posture reliability determination unit 108 sets the reference posture for calculating the posture information. As the reference posture, the information on the posture determined in advance at the home position of the radiation imaging apparatus 10 is set. When the reference posture is set, the posture reliability determination unit 108 advances the flow to Step S1001.

In Step S1001, the posture reliability determination unit 108 acquires the accelerations and the angular velocities from the sensor unit 102. When the accelerations and the angular velocities are acquired, the posture reliability determination unit 108 advances the flow to Step S1002.

In Step S1002, the posture reliability determination unit 108 determines whether the apparatus state of the radiation imaging apparatus 10 is the sleep state or the ready state. When the posture reliability determination unit 108 determines that the apparatus state is the sleep state, the posture reliability determination unit 108 advances the flow to Step S1003. When the posture reliability determination unit 108 determines that the apparatus state is the ready state, the posture reliability determination unit 108 advances the flow to Step S1005.

In Step S1003, the posture reliability determination unit 108 determines, from the accelerations and the angular velocities, the presence or absence of the impact on the radiation imaging apparatus 10. The determination of the presence or absence of the impact can be made through, for example, comparison between the output of the value of each of the acceleration and the angular velocity on each axis and a predetermined value for determining the presence or absence of the impact that can be freely set by the user. For example, when the output value exceeds the predetermined value, it is possible to determine the presence of the impact. When the presence of the impact is determined, the posture reliability determination unit 108 advances the flow to Step S1004. When the absence of the impact is determined, the posture reliability determination unit 108 advances the flow to Step S1006.

In Step S1004, the control apparatus 12 notifies the user of the warning indicating the decrease in accuracy of the posture calculation and the requirement for the resetting. When the message for the warning is notified, the series of processing steps relating to the determination and the correction of the posture is finished. The details of the message for the warning have already been described in the first embodiment, and hence description herein is omitted.

In Step S1005, posture correction processing in the ready state illustrated in FIG. 11 is executed. When the posture correction processing is executed, the series of processing steps relating to the determination and the correction of the posture is finished.

In Step S1006, the posture is calculated from the accelerations and the angular velocities, and a calculation result thereof is displayed on the display unit 123. When the display of the information on the posture is finished, the series of processing steps relating to the determination and the correction of the posture is finished. The details of the information on the posture displayed on the display unit 123 have already been described in the first embodiment, and hence description herein is omitted.

With reference to FIG. 11, the posture correction processing in the ready state executed in Step S1005 is described next. When the posture correction processing is started, first in Step S1100, the posture reliability determination unit 108 determines, from the accelerations and the angular velocities, the presence or absence of the impact on the radiation imaging apparatus 10. When the presence of the impact is determined, the posture reliability determination unit 108 advances the flow to Step S1101. When the absence of the impact is determined, the posture reliability determination unit 108 advances the flow to Step S1104.

In Step S1101, the posture reliability determination unit 108 determines, from the posture information on the radiation imaging apparatus 10 and the radiation generation apparatus 13, whether or not the radiation imaging apparatus 10 and the radiation generation apparatus 13 are opposing each other within a predetermined angle range. For example, in a case in which the predetermined angle range is ±5 degrees, when a detection surface (radiation detection surface) of the radiation detection unit 101 of the radiation imaging apparatus 10 is in a range of ±5 degrees from 90 degrees with respect to an incident angle of the radiation emitted from the radiation generation apparatus 13, those apparatus are determined to be opposing each other within the predetermined angle range. When those apparatus are determined to be opposing each other, the posture reliability determination unit 108 advances the flow to Step S1102. When those apparatus are determined not to be opposing each other, the posture reliability determination unit 108 advances the flow to Step S1104.

In Step S1102, the posture derivation unit 103 corrects the accelerations and the angular velocities to be used for the posture calculation. At this time, the correction can be made through such a method as the method of setting the accelerations and the angular velocities to 0, or the method of making the interpolation through use of the preceding and following data, which is described in the fourth embodiment. When the correction of the accelerations and the angular velocities to be used for the posture calculation is finished, the posture reliability determination unit 108 advances the flow to Step S1103.

In Step S1103, the posture derivation unit 103 calculates the information on the posture from the accelerations and the angular velocities, and a calculation result thereof is displayed on the display unit 123. When the display of the posture is finished, the series of processing steps relating to the determination and the correction of the posture is finished.

In Step S1104, the control apparatus 12 notifies the user of the warning indicating the decrease in accuracy of the posture calculation and the requirement for the resetting. When the message for the warning is notified, the series of processing steps relating to the determination and the correction of the posture is finished.

As described above, according to the fifth embodiment, it is possible to acquire accurate information on the posture which is not influenced by the impact caused by the contact of the radiation imaging apparatus 10 with the imaging support or the object at the time of the execution of the imaging preparation. Further, it is possible to grasp the state of the imaging preparation by referring to the apparatus state and the information on the opposing state. Thus, it is possible to achieve appropriate correction of the posture and warning notification, and hence it is possible to reduce a load on the imaging preparation and a load on the object.

### Sixth Embodiment

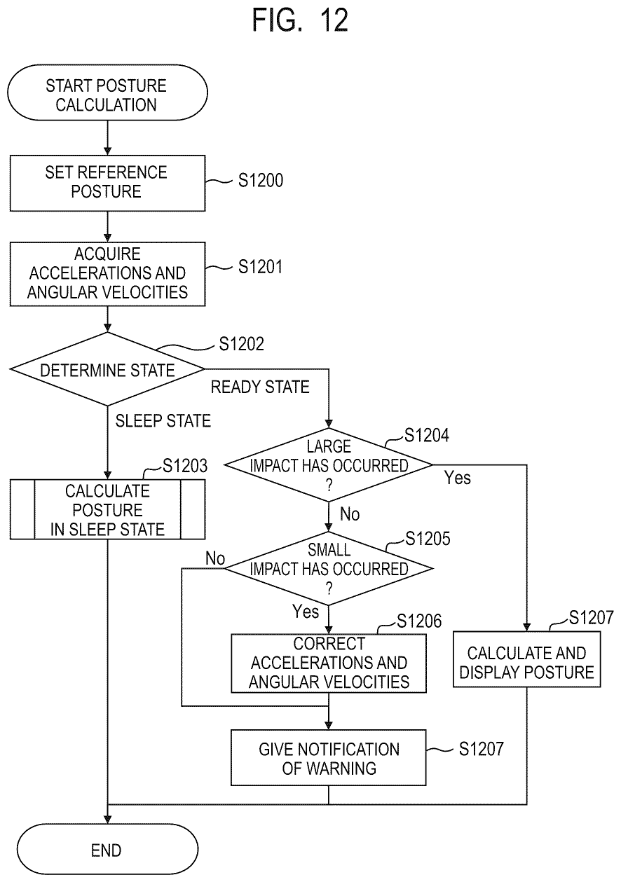

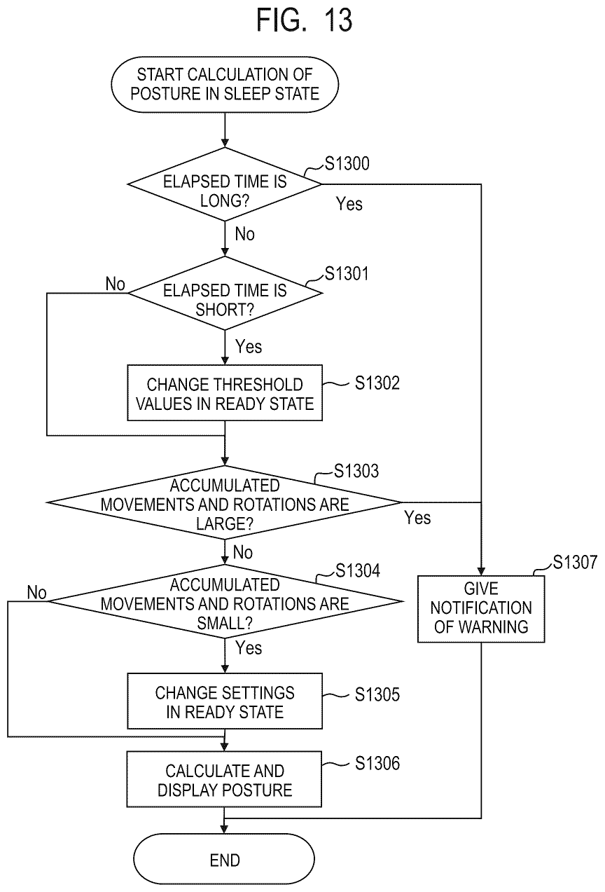

In a sixth embodiment, the information on the posture at the time of the occurrence of the impact is corrected in accordance with the reliability decrease in reference posture and magnitudes of the impact relating to the radiation imaging apparatus 10. With reference to flowcharts of FIG. 12 and FIG. 13, a method of determining the presence or absence of the impact and correcting the information on the posture is now described. A configuration of the radiation imaging system according to the sixth embodiment is the same as that in the first embodiment, and hence description herein is omitted.

In the sixth embodiment, the determination of the presence or absence of the impact can be made based on, for example, the value of each of the acceleration and the angular velocity on each axis output by the sensor unit 102. In the fourth embodiment and the fifth embodiment, one predetermined value is used for the determination of the presence or absence of the impact, but, in the sixth embodiment, the user is allowed to set any large and small two predetermined types of values as the threshold value used for the determination. The large one of the threshold values out of the large and small two types of the threshold values is referred to as “large threshold value.” The small one of the threshold values out of the large and small two types of the threshold values is referred to as “small threshold value.” The posture reliability determination unit 108 can determine that presence of large impact when each output value of the accelerations and the angular velocities exceeds the predetermined large threshold value, and can determine that presence of small impact when each output value of the accelerations and the angular velocities exceeds the predetermined small threshold value.

Moreover, in the sixth embodiment, the determination of the reliability decrease in posture information can be made also based on sums of the movement amounts and the rotation amounts of the sensor unit 102 since the last setting of the reference posture. In this case, also for threshold values for the movement amount and the rotation amount used for the determination of magnitudes of the movement amount and the rotation amount, the user is allowed to set any large and small two predetermined types of threshold values which are large threshold value and small threshold value in the same manner as in the threshold values for the impact.

Further, in the sixth embodiment, the determination of the reliability decrease in posture information can be made based on the elapsed time since the last setting of the reference posture. In this case, also for the threshold value used for the reliability determination based on the elapsed time, the user is allowed to set any large and small two predetermined types of threshold values which are large threshold value and small threshold value.

With reference to FIG. 12, a method of determining the presence or absence of the impact and correcting the information on the posture is described. When the posture correction processing is started, first, in Step S1200, the posture reliability determination unit 108 sets the reference posture for calculating the posture information. As the reference posture, the information on the posture determined in advance at the home position of the radiation imaging apparatus 10 is set. When the reference posture is set, the posture reliability determination unit 108 advances the flow to Step S1201.

In Step S1201, the posture reliability determination unit 108 acquires the accelerations and the angular velocities from the sensor unit 102. When the accelerations and the angular velocities are acquired, the posture reliability determination unit 108 advances the flow to Step S1202.

In Step S1202, the posture reliability determination unit 108 determines whether the apparatus state of the radiation imaging apparatus 10 is the sleep state or the ready state. When the posture reliability determination unit 108 determines that the apparatus state is the sleep state, the posture reliability determination unit 108 advances the flow to Step S1203. When the posture reliability determination unit 108 determines that the apparatus state is the ready state, the posture reliability determination unit 108 advances the flow to Step S1204.

In Step S1203, the posture calculation processing in the sleep state, details of which are illustrated in FIG. 13, is executed. When the posture calculation processing of FIG. 13 is executed, and the display of the calculated posture and the like are executed, the series of processing steps relating to the determination and the correction of the posture in the sixth embodiment is finished.

In Step S1204, the posture reliability determination unit 108 makes the determination for the presence or absence of the large impact or the falling of the radiation imaging apparatus 10. Specifically, the presence or absence of the large impact or the falling is determined through the comparison between the above-mentioned predetermined large threshold value and the corresponding output value based on whether this output value exceeds the predetermined large threshold value. When the presence of the large impact or the falling is determined, the posture reliability determination unit 108 advances the flow to Step S1208. When the absence of the large impact is determined, the posture reliability determination unit 108 advances the flow to Step S1205.

In Step S1205, the posture reliability determination unit 108 determines the presence or absence of the small impact. Specifically, the presence or absence of the small impact is determined through the comparison between the above-mentioned predetermined small threshold value and the corresponding output value used in Step S1204 based on whether or not this output value exceeds the predetermined small threshold value. When the presence of the small impact is determined, the posture reliability determination unit 108 advances the flow to Step S1206. When the absence of the small impact is determined, the posture reliability determination unit 108 advances the flow to Step S1207.

In Step S1206, the accelerations and the angular velocities used for the calculation of the information on the posture are corrected. As a method of making the correction described here, it is only required to use, for example, a method of making the interpolation through use of the preceding and following data described in the fourth embodiment. When the correction of the accelerations and the angular velocities used for the calculation of the information on the posture is finished, the posture reliability determination unit 108 advances the flow to Step S1207.

In Step S1207, the posture derivation unit 103 calculates the information on the posture from the accelerations and the angular velocities. The calculated information on the posture is transmitted to the control apparatus 12, and this information on the posture is displayed on the display unit 123 by the control unit 120. When the display of the information on the posture is finished, the series of processing steps relating to the determination and the correction of the posture is finished.

In Step S1208, the control apparatus 12 notifies the user of the warning indicating the decrease in accuracy of the posture calculation and the requirement for the resetting. When the message for the warning is notified, the series of processing steps relating to the determination and the correction of the posture is finished. The details of the message for the warning have already been described in the first embodiment, and hence description herein is omitted.

With reference to FIG. 13, the calculation processing for the information on the posture in the sleep state executed in Step S1203 is described next. When the correction processing for the information on the posture is started, first, in Step S1300, the posture reliability determination unit 108 determines whether or not the elapsed time since the last setting of the reference posture has exceeded the predetermined large threshold value. When the elapsed time is determined to have exceeded the predetermined large threshold value, the posture reliability determination unit 108 advances the flow to Step S1307. When the elapsed time is determined not to have exceeded the predetermined large threshold value, the posture reliability determination unit 108 advances the flow to Step S1301.

In Step S1301, the posture reliability determination unit 108 determines whether or not the elapsed time since the last setting of the reference posture has exceeded the predetermined small threshold value. When the elapsed time is determined to have exceeded the predetermined small threshold value, the posture reliability determination unit 108 advances the flow to Step S1302. When the elapsed time is determined not to have exceeded the predetermined small threshold value, the posture reliability determination unit 108 advances the flow to Step S1303.

In Step S1302, the posture reliability determination unit 108 changes the threshold values for determining the presence or absence of the impact used in Step S1204 and Step S1205. In the sixth embodiment, the threshold values after the change are also allowed to be freely changed by the user, but may be set in advance or may be set by the posture reliability determination unit 108 in accordance with differences between the threshold value and the corresponding evaluation value. At this time, when the reliability of the information on the posture is assumed to have decreased as a result of passing through the sleep state, it is possible to reduce the threshold values (large threshold values) for the large impact from those at the usual time to notify the warning. When the threshold values are changed, the posture reliability determination unit 108 advances the flow to Step S1303.

In Step S1303, the posture reliability determination unit 108 determines whether or not each of the movement amounts and the rotation amounts since the last setting of the reference posture has exceeded the predetermined large threshold value. When the movement amount or the rotation amount is determined to have exceeded the predetermined large threshold value, the posture reliability determination unit 108 advances the flow to Step S1307. When the movement amount or the rotation amount is determined not to have exceeded the predetermined large threshold value, the posture reliability determination unit 108 advances the flow to Step S1304.

In Step S1304, the posture reliability determination unit 108 determines whether or not each of the movement amounts and the rotation amounts since the last setting of the reference posture has exceeded the predetermined small threshold value. That is, it is determined whether or not the sums of the change amounts of the position and the posture calculated based on the information on the posture since the reference posture was set have exceeded the threshold values for the sums provided in correspondence to those sums. When the movement amount or the rotation amount is determined to have exceeded the predetermined small threshold value, the posture reliability determination unit 108 advances the flow to Step S1305. When the movement amount or the rotation amount is determined not to have exceeded the predetermined small threshold value, the posture reliability determination unit 108 advances the flow to Step S1306.

In Step S1305, in the same manner as in Step S1302, the threshold values for determining the presence or absence of the impact used in Step S1204 and Step S1205 are changed. Moreover, in this step, the resolution of the sensor unit may be changed. At this time, it is preferred to change the setting such that the resolution of the sensor unit is increased to decrease an output range, to thereby increase the accuracy of the sensor output under a state in which the number of error components is small, and the resolution of the sensor unit is decreased to increase the output range when the number of error components is increased. When the threshold value and the resolution are changed, the posture reliability determination unit 108 advances the flow to Step S1306.

In Step S1306, the posture derivation unit 103 calculates the information on the posture from the accelerations and the angular velocities. The calculated information on the posture is transmitted to the control apparatus 12, and this information on the posture is displayed on the display unit 123 by the control unit 120. When the display of the information on the posture is finished, the series of processing steps relating to the calculation of the posture is finished.

In Step S1307, the control apparatus 12 notifies the user of the warning indicating the decrease in accuracy of the posture calculation and the requirement for the resetting. When the message for the warning is notified, the series of processing steps relating to the calculation of the posture is finished. The details of the message for the warning have already been described in the first embodiment, and hence description herein is omitted.

As described above, according to the sixth embodiment, in accordance with the reliability of the calculated information on the posture, the control apparatus 12 can control the notification of the requirement for the resetting of the reference posture to the user. That is, the user can know whether it is required to acquire the information on the posture at an appropriate timing. Further, by executing the correction processing at the time of the impact detection in accordance with the reliability, it is possible to acquire accurate information on the posture which is not influenced by the impact caused by the contact of the radiation imaging apparatus with the imaging support or the object at the time of the execution of the imaging preparation.

### Modification Examples

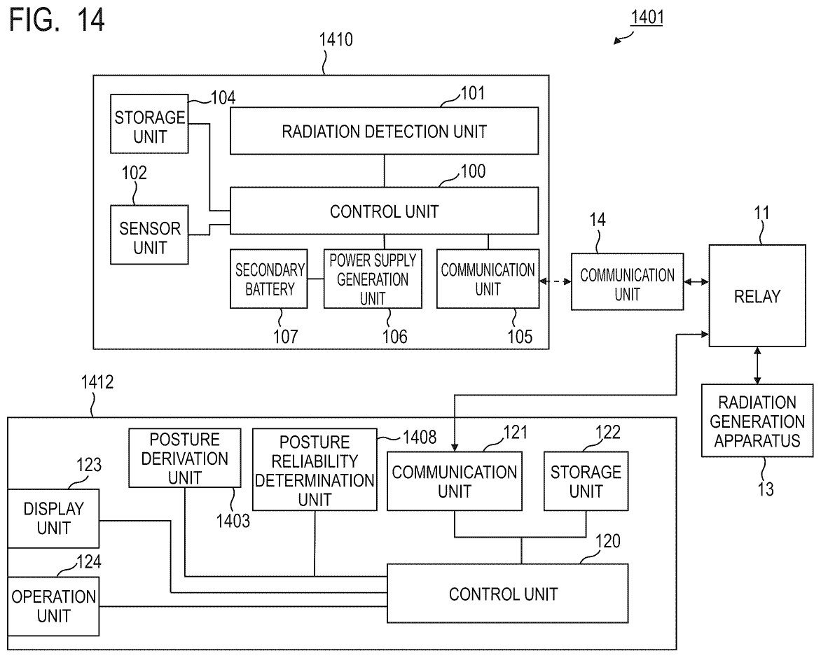

In the embodiments described above, the posture derivation unit 103 and the posture reliability determination unit 108 are arranged inside the radiation imaging apparatus 10. However, the arrangement of those components is not limited to the example in the embodiments. With reference to FIG. 14, a modification example in which those components are arranged outside the radiation imaging apparatus 10 is described. FIG. 14 is a functional block diagram for illustrating a configuration example of a radiation imaging system according to the modification example of the present disclosure.

As illustrated in FIG. 14, this modification example is different in a radiation imaging apparatus 1410 and a control apparatus 1412. In more detail, as components corresponding to the posture derivation unit and the posture reliability determination unit described in the first embodiment, a posture derivation unit 1403 and a posture reliability determination unit 1408 are arranged inside the control apparatus 1412. In this configuration, the sensor unit 102 transmits information such as the accelerations, the angular velocities, and the quaternion to the control apparatus 12 via communication. The information on the posture is calculated by the posture derivation unit 1403 arranged in the control apparatus 1412. After that, the posture reliability determination unit 1408 determines the posture reliability based on the calculated information on the posture. The remaining configuration in this modification example is the same as the configuration described with reference to FIG. 1, and hence description herein is omitted.

Moreover, the posture derivation units 103 and 1403 and the posture reliability determination units 108 and 1408 may not be arranged in the same apparatus, but may be arranged in, for example, apparatus different from each other. For example, it is possible to arrange the posture calculation unit in the radiation generation apparatus, and to arrange the reliability determination unit in the control apparatus. As another example, those components may be configured such that the posture calculation unit and the reliability determination unit are included in any of other configurations included in an imaging system connected via communication.

Moreover, the present disclosure can form, as the information processing apparatus, the control apparatus 1412 which processes the information acquired from the radiation imaging apparatus which executes radiation imaging based on the emitted radiation.

In this case, the radiation imaging apparatus 1410 includes the radiation detection unit 101 which detects the radiation, and the sensor unit 102 which outputs the data serving as the basis of the information on the posture of the radiation imaging apparatus.

The information processing apparatus 1412 is connected to this radiation imaging apparatus 1410. In this aspect, the control unit 120 functions as the acquisition unit which acquires the information on the posture output from the sensor unit 102 via the communication unit 121. The posture reliability determination unit 1408 determines the reliability of the information on the posture through use of the threshold value relating to the reliability of the information on the posture and the evaluation value exemplified in the first embodiment and the second embodiment.

In the above-mentioned embodiments, the acceleration sensor and the angular velocity sensor are provided to the sensor unit 102, and the output thereof is used to calculate the posture information by the posture derivation unit 103. However, the information of the geomagnetic sensor may be output from the sensor unit 102, to thereby calculate the posture information. When the geomagnetic sensor is used, the information thereof can be used to calculate angle information on the radiation imaging apparatus. In this case, it is required to initially calibrate a direction of the geomagnetism serving as a reference, and the direction of the geomagnetism obtained through this calibration is used as a reference direction to set a reference position required for the geomagnetic sensor. Also for this setting for the reference direction, the reliability determination in the embodiments can be made. As a result, the user can know whether it is required to acquire the information on the posture at an appropriate timing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Moreover, the implementation of the functions in the above-mentioned embodiments is not limited to the computer executing the read program code. A case in which an operating system (OS) running on a computer or the like executes a part or the whole of actual processing based on an instruction of this program code and the functions of the above-mentioned embodiments are implemented by this processing is also included.

Further, the program code read out from the recording medium may be written to a memory provided to a function extension board inserted into the computer or a function extension unit connected to the computer. A case in which a CPU or the like provided to the function extension board or the function extension unit executes a part or the whole of the actual processing based on the instruction of this program code and the above-mentioned functions are implemented by this processing is also included.

According to one aspect of the present disclosure, it is possible to know whether it is required to acquire the information on the posture at an appropriate timing in the radiation imaging system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-183116, filed Oct. 25, 2023, and Japanese Patent Application No. 2024-070255, filed Apr. 24, 2024, which are hereby incorporated by reference herein in their entirety.

What is claimed is:

1. A radiation imaging apparatus for executing radiation imaging based on emitted radiation, the radiation imaging apparatus comprising a determination unit configured to determine reliability of information on a posture of the radiation imaging apparatus obtained based on data output from a sensor through use of a threshold value relating to the reliability of the information on the posture and an evaluation value generated based on information on the radiation imaging apparatus including the information on the posture.

2. The radiation imaging apparatus according to claim 1, wherein the determination unit is connected to a notification unit configured to notify, when the evaluation value falls below the threshold value and the determination unit determines that the reliability of the information on the posture has decreased, a user of the decrease in reliability.

3. The radiation imaging apparatus according to claim 2, wherein the notification unit includes a display control unit configured to cause a display unit to execute display for notifying the user of the decrease in reliability.

4. The radiation imaging apparatus according to claim 1, wherein the evaluation value is calculated based on the information on the posture and a reference posture which is set for the radiation imaging apparatus.

5. The radiation imaging apparatus according to claim 4, wherein the determination unit is connected to a notification unit configured to notify, when the evaluation value falls below the threshold value and the determination unit determines that the reliability of the information on the posture has decreased, a user that resetting of the reference posture is required.

6. The radiation imaging apparatus according to claim 5, wherein the notification unit includes a display control unit configured to cause a display unit to execute at least one of display for notifying the user of the decrease in reliability or display for notifying that the resetting is required.

7. The radiation imaging apparatus according to claim 1,
wherein the determination unit is connected to a notification unit configured to notify a user of information which is based on the information on the posture, and
wherein the notification unit is configured to stop notifying the user of the information which is based on the information on the posture when the evaluation value falls below the threshold value and the determination unit determines that the reliability of the information on the posture has decreased.

8. The radiation imaging apparatus according to claim 7, wherein the information on the posture is information on rotation angles in three axial directions orthogonal to one another including a rotation angle about an axis parallel to gravity.

9. The radiation imaging apparatus according to claim 4, wherein the evaluation value and the threshold value include at least one of sums of change amounts of the posture and a position of the radiation imaging apparatus calculated based on the information on the posture since the setting of the reference posture and threshold values for the sums of change amounts, an average of at least one of an acceleration or an angular velocity of the radiation imaging apparatus calculated based on the information on the posture since the setting of the reference posture and a threshold value for the average, or information on one of an impact value applied to the radiation imaging apparatus or falling of the radiation imaging apparatus calculated based on the information on the posture since the setting of the reference posture and a threshold value for the information on the one of the impact value or the falling.

10. The radiation imaging apparatus according to claim 1,
wherein the information on the radiation imaging apparatus includes at least one of presence or absence of a change in information on a patient being a target of the radiation imaging, presence or absence of a change in a form of communication including at least one of a wired form or a wireless form to and from an external apparatus arranged independently of the radiation imaging apparatus and connected to a communication unit in the form of communication, presence or absence of a change of a wireless communication unit in setting of wireless communication to and from an external apparatus arranged independently of the radiation imaging apparatus and connected via the wireless communication unit, or presence or absence of a change in a state from a sleep state to a ready state of the radiation imaging apparatus, and
wherein the determination unit is configured to determine that the reliability falls below the threshold value when at least one of the change in the information on the patient, the change in the form of communication, the change in the setting, or the change in the state occurs as the evaluation value.

11. The radiation imaging apparatus according to claim 10, wherein the determination unit is connected to a notification unit configured to notify a user that resetting of a reference posture of the radiation imaging apparatus which is set to generate the information on the posture is required when the determination unit determines that the reliability has decreased.

12. The radiation imaging apparatus according to claim 1, further comprising:
a radiation detection unit configured to detect the radiation; and
a sensor unit configured to output data serving as a basis of the information on the posture.

13. The radiation imaging apparatus according to claim 1, wherein the information on the posture is corrected when the evaluation value falls below the threshold value and the determination unit determines that the reliability of the information on the posture has decreased.

14. The radiation imaging apparatus according to claim 13, further comprising:
a radiation detection unit configured to detect the radiation; and
a sensor unit configured to output data serving as a basis of the information on the posture.

15. The radiation imaging apparatus according to claim 14, wherein the threshold value is a threshold value relating to data on at least one of an acceleration or an angular velocity output by the sensor unit, the evaluation value is a value of output of the sensor unit corresponding to the threshold value, and the information to be corrected is a value of the output of the sensor unit.

16. The radiation imaging apparatus according to claim 13, wherein the information on the posture is corrected when a radiation detection surface of a radiation detection unit configured to detect the radiation opposes an incident direction of the radiation within a predetermined angle range.

17. The radiation imaging apparatus according to claim 13,
wherein the threshold value relating to the reliability includes a threshold value relating to the reliability of the information on the posture of the radiation imaging apparatus in a sleep state and a threshold value relating to the reliability of the information on the posture of the radiation imaging apparatus in a ready state, and
wherein the determination unit is configured to change the threshold value relating to the reliability in the ready state in accordance with a result of determination relating to the reliability in the sleep state.

18. A radiation imaging system comprising:
a radiation generation apparatus configured to generate radiation;
a control apparatus configured to control the radiation generation apparatus; and
the radiation imaging apparatus of claim 1.

19. A method of controlling a radiation imaging apparatus for executing radiation imaging based on emitted radiation, the method comprising determining reliability of information on a posture of the radiation imaging apparatus obtained based on data output from a sensor through use of a threshold value relating to the reliability of the information on the posture and an evaluation value generated based on information on the radiation imaging apparatus including the information on the posture.

20. A storage medium having stored thereon a program for causing, when the program is executed by a processor, the processor to execute the method of controlling a radiation imaging apparatus of claim 19.
